(19) United States
(12) Patent Application Publication
(10) Pub. No.: US 2025/0004007 A1
(43) Pub. Date: Jan. 2, 2025

(54) MOTION ACQUISITION APPARATUS, MOTION ACQUISITION METHOD, AND MOTION ACQUISITION PROGRAM

(71) Applicant: NIPPON TELEGRAPH AND TELEPHONE CORPORATION, Tokyo (JP)

(72) Inventors: Wakana OSHIRO, Tokyo (JP); Motohiro MAKIGUCHI, Tokyo (JP); Ryuji YAMAMOTO, Tokyo (JP)

(73) Assignee: NIPPON TELEGRAPH AND TELEPHONE CORPORATION, Tokyo (JP)

(21) Appl. No.: 18/709,818

(22) PCT Filed: Nov. 30, 2021
(86) PCT No.: PCT/JP2021/043901

§ 371 Date: May 14, 2024

(51) Int. Cl. G01P 15/18; G01P 1/07

(52) U.S. Cl. CPC G01P 15/18; G01P 1/07

(57) ABSTRACT

This invention can acquire a difference in motion of a motion acquisition target object without detecting the difference from the outside of the motion acquisition target object. A motion acquisition device includes two acceleration sensors, an information acquisition unit, and a motion analysis unit. The two acceleration sensors are arranged in the motion acquisition target object rotated around a rotation axis. The information acquisition unit acquires acceleration information detected by the two acceleration sensors. Based on the acceleration information acquired by the information acquisition unit, the motion analysis unit estimates a distance from one of the acceleration sensors to the rotation axis and an attitude angle of the motion acquisition target object.

### TECHNICAL FIELD

One aspect of this invention relates to a motion acquisition device, a motion acquisition method, and a motion acquisition program.

### BACKGROUND ART

In a remote online event or the like, it is difficult to share a reaction between a performer and an audience or a reaction between audiences, as compared with an on-site event.

In an existing moving image streaming service, reactions can be shared by using text chat. However, a performer reading letters during performance and an audience writing and reading letters interfere with concentration on content itself, which is problematic.

For such a problem, there is a method of sharing a reaction of an audience by a nonverbal body motion. For example, motion of glow sticks is an element that most reflects motion of audiences in a dark concert hall. If such a motion of a motion acquisition target object such as a glow stick can be acquired and reproduced, sharing reactions between a performer and an audience and between audiences can be expected.

For example, Non Patent Literature 1 proposes a method of causing an audience to carry a virtual reality (VR) controller serving as a motion acquisition target object, estimating a motion of the audience on the basis of a motion of the VR controller, and reproducing the motion in a VR space. In the method, information regarding an absolute position and attitude angle of the VR controller is sensed by an infrared transmitter/receiver installed in an environment. Therefore, the following problems occur, for example: the transmitter/receiver is required, and installation and calibration of the transmitter/receiver are costly; it is necessary to secure an installation place; and a use range is limited to a sensable range.

Therefore, as a simple mounting method for acquiring a motion of an audience by using only a sensor included in a motion acquisition target object gripped by the audience without requiring an external sensor in an environment, there is, for example, a method of installing one six-axis sensor (acceleration+angular velocity) in a motion acquisition target object to estimate an attitude angle of the motion acquisition target object. However, only by reproducing the estimated attitude angle as it is in the VR space, it is impossible to acquire a difference in motion between a case where the audience swings the motion acquisition target object around the wrist and a case where the audience swings the motion acquisition target object around the elbow. Thus, it is impossible to accurately present the motion of the motion acquisition target object.

It is also possible to compensate for the above in principle by integrating an acceleration acquired by an acceleration sensor in addition to the attitude angle and calculating an absolute position of the motion acquisition target object. However, the absolute position cannot be acquired with sufficient accuracy due to noise by using only the acceleration sensor.

### CITATION LIST

### Non Patent Literature

Non Patent Literature 1: Yamashita et al., “VR-Based Remote Live Music Support System: KSA2”, Technical Report of Information Processing Society of Japan, 2018

### SUMMARY OF INVENTION

### Technical Problem

This invention has been made in view of the above circumstances, and an object thereof is to provide a motion acquisition device, a motion acquisition method, and a motion acquisition program, each of which is capable of acquiring a difference in motion of a motion acquisition target object without detecting the difference from the outside of the motion acquisition target object.

### Solution to Problem

In order to solve the above problems, a motion acquisition device according to an aspect of this invention includes two acceleration sensors, an information acquisition unit, and a motion analysis unit. The two acceleration sensors are arranged in the motion acquisition target object rotated around a rotation axis. The information acquisition unit acquires acceleration information detected by the two acceleration sensors. Based on the acceleration information acquired by the information acquisition unit, the motion analysis unit estimates a distance from one of the acceleration sensors to the rotation axis and an attitude angle of the motion acquisition target object.

### Advantageous Effects of Invention

According to one aspect of this invention, not only an attitude angle of a motion acquisition target object but also a rotation axis is estimated by using only two acceleration sensors arranged in the motion acquisition target object, and thus it is possible to provide a motion acquisition device, a motion acquisition method, and a motion acquisition program, each of which is capable of acquiring a difference in motion of the motion acquisition target object without detecting the difference from the outside of the motion acquisition target object.

### BRIEF DESCRIPTION OF DRAWINGS

FIG. 1 is a block diagram illustrating an example of an overview of a distribution system to which a motion acquisition device according to a first embodiment of this invention is applied.

FIG. 2 is a block diagram illustrating an example of a configuration of a motion acquisition device according to the first embodiment.

FIG. 3 is a schematic diagram illustrating an example of a motion acquisition target object serving as an input device of FIG. 2.

FIG. 4 is a block diagram illustrating an example of a configuration of a distribution server of FIG. 2.

FIG. 5 is a schematic diagram illustrating a motion of a glow stick in a case where the glow stick is swung from an attitude angle of 0 degrees to the attitude angle of 45 degrees around a rotation axis outside the glow stick.

FIG. 6 is a schematic diagram illustrating a motion of a glow stick in a case where the glow stick is swung from the attitude angle of 0 degrees to the attitude angle of 45 degrees around a rotation axis inside the glow stick.

FIG. 7 is a flowchart showing a processing routine in a motion acquisition device.

FIG. 8 is a schematic diagram illustrating a relationship between a position of a rotation axis and an acceleration vector of each acceleration sensor included in a motion acquisition target object.

FIG. 9 illustrates acceleration vectors in the same coordinate system.

FIG. 10 illustrates a relationship between the world coordinate system and a coordinate system of a motion acquisition target object.

FIG. 11 illustrates a swing direction in a case where a coordinate system of a motion acquisition target object is fixed with respect to the world coordinate system.

FIG. 12 illustrates variables used for estimating a rotation axis in a case where the rotation axis is located outside a motion acquisition target object.

FIG. 13 illustrates variables used for estimating a rotation axis in a case where the rotation axis is located inside a motion acquisition target object.

FIG. 14 illustrates variables used for calculating an attitude angle in a case where the rotation axis is located outside a motion acquisition target object.

FIG. 15 illustrates variables used for calculating an attitude angle in a case where the rotation axis is located inside a motion acquisition target object.

FIG. 16 illustrates a method of reflecting a position of a rotation axis in video display of a motion acquisition target object in a case where the rotation axis is located outside the motion acquisition target object.

FIG. 17 illustrates a method of reflecting a position of a rotation axis in video display of a motion acquisition target object in a case where the rotation axis is located inside the motion acquisition target object.

FIG. 18 illustrates a method of reflecting an attitude angle in video display of a motion acquisition target object.

FIG. 19 illustrates a block diagram illustrating an example of a configuration of a motion acquisition device according to a second embodiment of this invention.

FIG. 20 is a schematic diagram illustrating an example of a motion acquisition target object serving as an input device of FIG. 17.

FIG. 21 is a flowchart showing a processing routine in a motion acquisition device according to the second embodiment.

FIG. 22 illustrates variables used for estimating a rotation axis in a case where the rotation axis is located outside a motion acquisition target object.

FIG. 23 illustrates variables used for estimating a rotation axis in a case where the rotation axis is located inside a motion acquisition target object.

FIG. 24 illustrates a block diagram illustrating an example of a configuration of a motion acquisition device according to a third embodiment of this invention.

FIG. 25 is a schematic diagram illustrating an example of an arrangement position of a geomagnetic sensor in a motion acquisition target object.

FIG. 26 is a block diagram illustrating another example of the configuration of the motion acquisition device according to the third embodiment.

### DESCRIPTION OF EMBODIMENTS

Embodiments according to this invention will be described below with reference to the drawings.

### First Embodiment

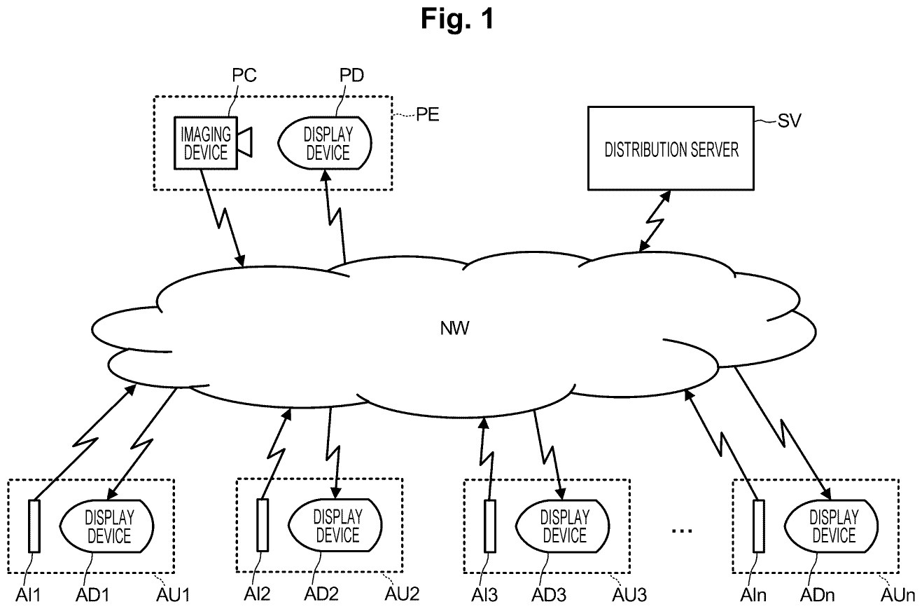

FIG. 1 is a block diagram illustrating an example of an overview of a distribution system to which a motion acquisition device according to a first embodiment of this invention is applied. The distribution system is a system in which a distribution server SV distributes a video of a performer PE to a plurality of audiences AU1, AU2, AU3, . . . , and AUn via a network NW such as the Internet. An imaging device PC and a display device PD are arranged in a concert venue where the performer PE is giving a performance. The imaging device PC can include a plurality of cameras. The audiences AU1, AU2, AU3, . . . , and AUn possess display devices AD1, AD2, AD3, . . . , and ADn and input devices AI1, AI2, AI3, . . . and AIn. Hereinafter, the audiences AU1, AU2, AU3, . . . , and AUn, the display devices AD1, AD2, AD3, . . . , and ADn, and the input devices AI1, AI2, AI3, . . . , and AIn will be denoted by the audiences AU, the display devices AD, and the input devices AI, without being particularly distinguished.

A live video of the performer PE is captured by the imaging device PC and is transmitted to the distribution server SV via the network NW. The distribution server SV distributes the live video captured by the imaging device PC to the display device AD of each audience AU via the network NW and displays the live video on the display device AD. The distribution server SV may create and distribute a VR video on the basis of the live video captured by the imaging device PC. In this case, the display device AD of the audience AU can be a head mounted display (HMD) worn on a head of the audience AU.

The input device AI of the audience AU transmits an input signal to the distribution server SV via the network NW. The distribution server SV analyzes a motion of the input device AI on the basis of the input signal. Then, the distribution server SV transmits a video in which the motion of the input device AI is reproduced to the display device PD of the performer PE on the basis of the analyzed motion. For example, the display device PD may be a plurality of large displays surrounding the performer PE or may be augmented reality (AR) glasses. For the audience AU who is watching a VR video, the distribution server SV can include a video of the input device AI of another audience AU in the VR video.

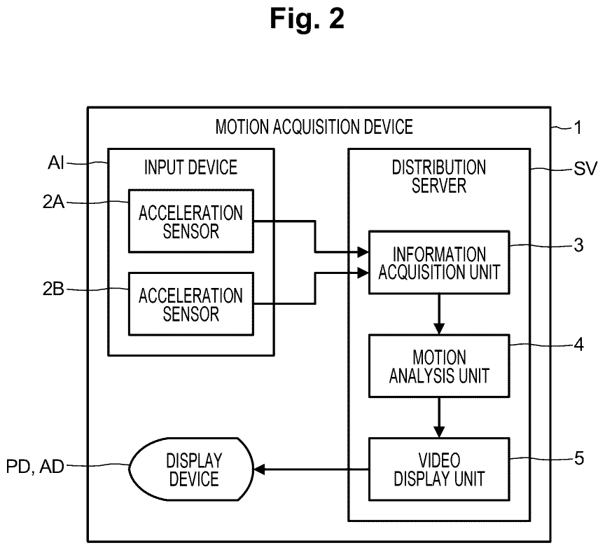

FIG. 2 is a block diagram illustrating an example of a configuration of a motion acquisition device 1 according to the first embodiment. As illustrated in FIG. 2, the motion acquisition device 1 includes the input device AI of each audience AU, the distribution server SV, and the display device PD of the performer PE and/or the display device AD of each audience AU. The input device AI is a motion acquisition target object and includes two acceleration sensors 2A and 2B. The distribution server SV includes an information acquisition unit 3, a motion analysis unit 4, and a video display unit 5.

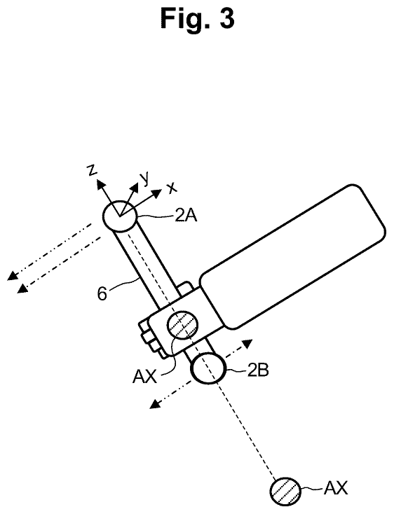

FIG. 3 is a schematic diagram illustrating an example of the motion acquisition target object serving as the input device AI. As illustrated in FIG. 3, the input device AI is provided in the form of a glow stick 6 gripped by the audience AU in the present embodiment. The two acceleration sensors 2A and 2B are arranged to be separated from each other in an elongated cylindrical rigid body forming the glow stick 6. The acceleration sensors may be arranged in the form of being attached to a surface of the glow stick 6. However, considering that the glow stick is swung by the audience AU, that is, is rotated around a certain rotation axis AX, the acceleration sensors are desirably included in the glow stick 6. A direction of the separation is a radial direction of the rotation, that is, a longitudinal direction of the cylindrical glow stick 6. Further, an interval of the separation is desirably as wide as possible because motion analysis accuracy is higher as a distance increases. In the present embodiment, the two acceleration sensors 2A and 2B are arranged at both ends on a longitudinal axis of the cylindrical glow stick 6. The two acceleration sensors 2A and 2B are arranged in the glow stick 6 such that directions of three axes (x-axis, y-axis, and z-axis) of detection by the acceleration sensors are aligned and that the z-axis direction is the longitudinal direction of the cylindrical glow stick 6.

The information acquisition unit 3 has a function of acquiring acceleration information detected by the two acceleration sensors 2A and 2B of each glow stick 6 via the network NW.

The motion analysis unit 4 has a function of, based on the acceleration information acquired by the information acquisition unit 3, estimating whether or not the rotation axis AX is located between the two acceleration sensors 2A and 2B, that is, whether the rotation axis AX is located inside or outside the glow stick 6, a distance from the acceleration sensor to the rotation axis AX, and an attitude angle of each glow stick 6. The acceleration sensor whose distance from the rotation axis AX is to be estimated may be any one of the two acceleration sensors 2A and 2B of each glow stick 6. As indicated by one-dot dashed line arrows and two-dot dashed line arrows in FIG. 3, directions of acceleration vectors from the two acceleration sensors 2A and 2B are different depending on whether the rotation axis AX is located inside or outside the glow stick 6. That is, in a case where the rotation axis AX is located inside the glow stick 6, acceleration is applied in opposite directions to the two acceleration sensors 2A and 2B as indicated by the one-dot dashed line arrows. Meanwhile, in a case where the rotation axis AX is located outside the glow stick 6, acceleration is applied in the same directions to the two acceleration sensors 2A and 2B as indicated by the two-dot dashed line arrows. Therefore, the motion analysis unit 4 can estimate a position of the rotation axis AX on the basis of the acceleration information. Details of a method of estimating the rotation axis AX and the attitude angle in the motion analysis unit 4 will be described later.

The video display unit 5 has a function of generating a video for displaying an image of each glow stick 6 on the basis of the distance from the rotation axis AX, the attitude angle of each glow stick 6, and whether the rotation axis AX is located inside or outside the glow stick 6, which are analyzed by the motion analysis unit 4. The video display unit 5 also has a function of transmitting the generated video to the display device PD of the performer PE and/or the display device AD of each audience AU via the network NW and displaying the video on the display device PD and/or the display device AD.

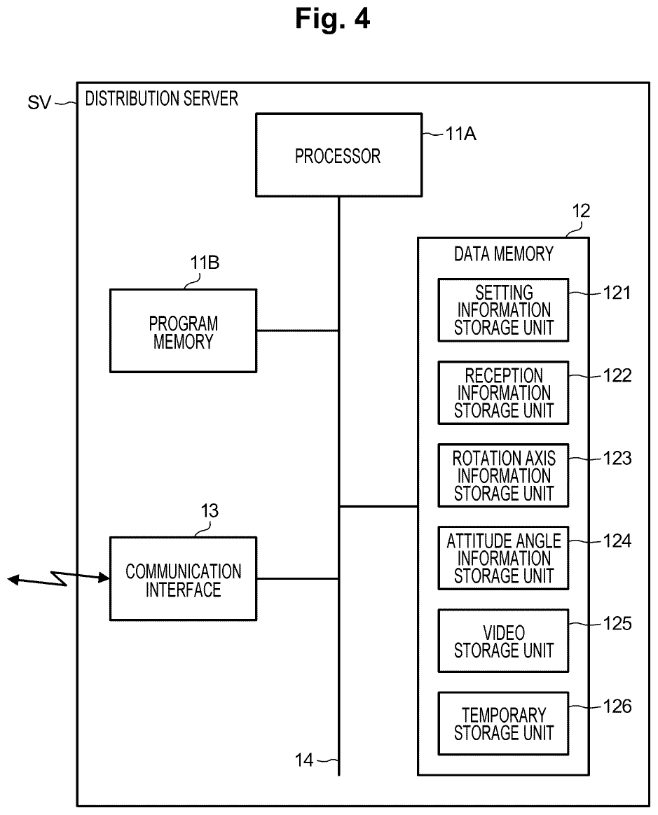

FIG. 4 is a block diagram illustrating an example of a configuration of the distribution server SV.

As illustrated in FIG. 4, the distribution server SV includes, for example, a personal computer (PC) and includes, for example, a processor 11A such as a central processing unit (CPU). The processor 11A may be a multi-core/multi-thread processor and can execute a plurality of pieces of processing in parallel. The motion acquisition device is configured such that a program memory 11B, a data memory 12, and a communication interface 13 are connected to the processor 11A via a bus 14.

The program memory 11B serving as a storage medium is, for example, a combination of a nonvolatile memory into/from which data can be written/read at any time, such as a hard disk drive (HDD) or a solid state drive (SSD), and a nonvolatile memory such as a read only memory (ROM). The program memory 11B stores programs necessary for the processor 11A to execute various types of processing. The programs include not only an operating system (OS) but also a motion acquisition program according to the first embodiment. When the processor 11A executes the motion acquisition program, it is possible to implement the information acquisition unit 3, the motion analysis unit 4, and the video display unit 5 as processing function units by software. Those processing function units may be implemented in various other formats including an integrated circuit such as an application specific integrated circuit (ASIC) and a field-programmable gate array (FPGA).

The data memory 12 is a storage including, as a storage medium, for example, a combination of a nonvolatile memory to/from which data can be written/read at any time, such as an HDD or SSD, and a volatile memory such as a random access memory (RAM). The data memory 12 is used to store data acquired and created in the process of performing various types of processing. A storage area of the data memory 12 includes, for example, a setting information storage unit 121, a reception information storage unit 122, a rotation axis information storage unit 123, an attitude angle information storage unit 124, a video storage unit 125, and a temporary storage unit 126.

The setting information storage unit 121 is a storage area for storing setting information acquired in advance by the processor 11A. The setting information includes, for example, a virtual position of each audience AU in the concert venue where the performer PE is performing, that is, a positional relationship between the performer PE and the audience AU, a relationship between a coordinate system of a screen of the display device AD and a coordinate system of the glow stick 6 for each audience AU, and the distance between the two acceleration sensors 2A and 2B of each input device AI.

The reception information storage unit 122 is a storage area for storing the acquired acceleration information when the processor 11A functions as the information acquisition unit 3 and acquires the acceleration information from the acceleration sensors 2A and 2B arranged in the glow stick 6 of each audience AU.

The rotation axis information storage unit 123 is a storage area for storing an analysis result when the processor 11A functions as the motion analysis unit 4 and analyzes information regarding the rotation axis AX for each audience AU, that is, the distance from the rotation axis AX and whether the rotation axis AX is located inside or outside the glow stick 6.

The attitude angle information storage unit 124 is a storage area for storing an analysis result when the processor 11A functions as the motion analysis unit 4 and analyzes the attitude angle of the glow stick 6 of each audience AU.

The video storage unit 125 is a storage area for storing the generated video when the processor 11A functions as the video display unit 5 and generates the video for displaying the image of the glow stick 6 of each audience AU.

The temporary storage unit 126 is a storage area for temporarily storing various types of data such as intermediate data generated in the middle of performing various types of processing when the processor 11A functions as the information acquisition unit 3, the motion analysis unit 4, and the video display unit 5.

As described above, each processing function unit of the motion acquisition device 1 can be implemented by the processor 11A that is a computer and the motion acquisition program stored in advance in the program memory 11B. However, the motion acquisition program may be recorded in a non-transitory computer-readable medium or may be provided for the motion acquisition device 1 via the network NW. The motion acquisition program thus provided can be stored in the program memory 11B. When the provided motion acquisition program is stored in the data memory 12 that is a storage and is executed by the processor 11A as necessary, the processor 11A can also function as each processing function unit.

The communication interface 13 is a wired or wireless communication unit for connecting to the network NW.

Although not particularly illustrated, the distribution server SV can include an input/output interface that is an interface with the input device and an output device. The input device includes, for example, a keyboard and a pointing device for a supervisor of the distribution server SV to input an instruction to the processor 11A. The input device can also include a reader for reading data to be stored in the data memory 12 from a memory medium such as a USB memory and a disk device for reading such data from a disk medium. The output device includes a display for displaying output data to be presented to a user from the processor 11A, a printer for printing the output data, and the like.

Next, a processing operation of the motion acquisition device 1 configured as described above will be described.

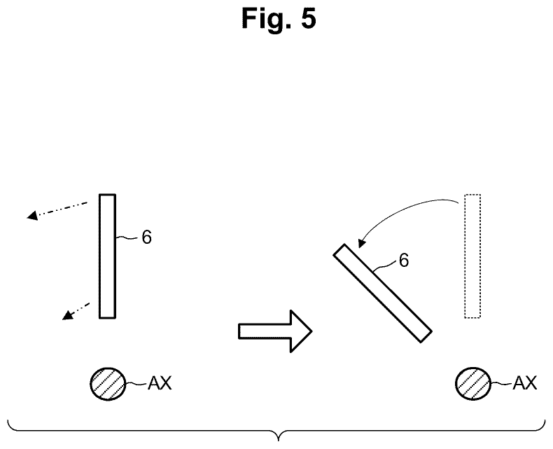

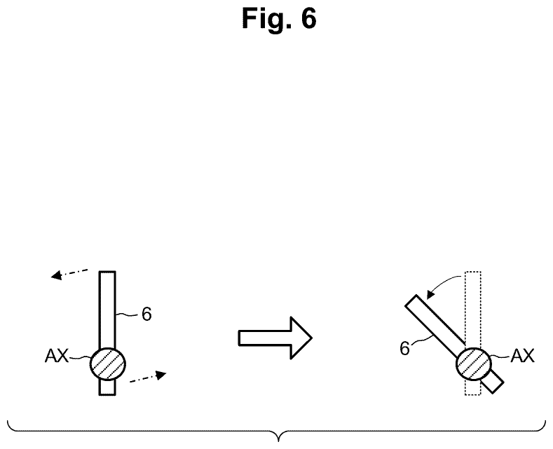

FIG. 5 is a schematic diagram illustrating a motion of the glow stick 6 in a case where the glow stick 6 is swung from the attitude angle of 0 degrees to the attitude angle of 45 degrees around the rotation axis AX outside the glow stick 6. FIG. 6 is a schematic diagram illustrating a motion of the glow stick in a case where the glow stick 6 is swung from the attitude angle of 0 degrees to the attitude angle of 45 degrees around the rotation axis AX inside the glow stick 6. FIG. 5 illustrates a case where, for example, the glow stick 6 is swung around the elbow as the rotation axis AX. Meanwhile, FIG. 6 illustrates a case where, for example, the glow stick 6 is swung around the wrist as the rotation axis AX. As indicated by broken line arrows in FIGS. 5 and 6, a magnitude of a motion locus of the glow stick 6 varies depending on a difference in the position of the rotation axis AX even in a case where the glow stick 6 has the same attitude angle. Therefore, it is necessary to reproduce the difference in the locus in a video of the glow stick to be displayed on the display device PD and/or AD by the video display unit 5 and to provide a video giving different appearances for the performer PE and/or the audience AU.

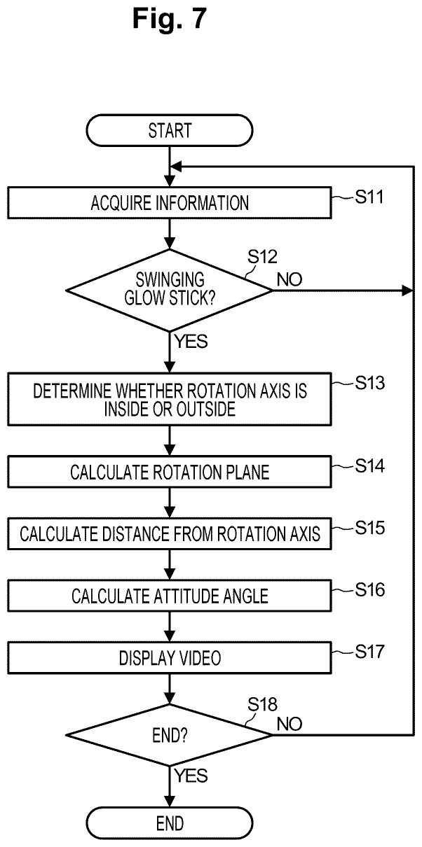

FIG. 7 is a flowchart showing a processing routine in the motion acquisition device 1 according to the first embodiment. The processor 11A of the motion acquisition device 1 can execute the processing in the flowchart by executing the motion acquisition program stored in advance in the program memory 11B, for example. The processor 11A executes the motion acquisition program when receiving an instruction to start viewing distribution from the audience AU via the network NW through the communication interface 13. Note that the processing routine in the flowchart shows processing for one input device AI, and the processor 11A can perform similar processing in parallel for the plurality of input devices AI.

The processor 11A operates as the information acquisition unit 3 to acquire acceleration information (step S11). That is, the processor 11A receives, through the communication interface 13, acceleration information transmitted via the network NW from the two acceleration sensors 2A and 2B arranged in the glow stick 6 serving as the input device AI and stores the acceleration information in the reception information storage unit 122 of the data memory 12.

The processor 11A determines whether or not the audience AU is swinging the glow stick 6 on the basis of the acceleration information stored in the reception information storage unit 122 (step S12). For example, the processor 11A can perform the determination on the basis of whether or not the sum of squares of accelerations in the x and y directions exceeds a threshold. When it is determined that the audience AU is not swinging the glow stick 6, the processor 11A proceeds to the processing in step S11 described above.

When it is determined that the audience AU is swinging the glow stick 6, the processor 11A determines whether the rotation axis AX is located inside or outside the glow stick 6 (step S13). For example, the processor 11A can perform the determination on the basis of an angle formed by acceleration vectors. Details of the determination method will be described later. The processor 11A stores the determination result in the rotation axis information storage unit 123 of the data memory 12.

The processor 11A calculates a rotation plane that is a swing direction of the glow stick 6 by using the setting information stored in the setting information storage unit 121 and the acceleration information stored in the reception information storage unit 122 (step S14). Details of the calculation method will be described later. The processor 11A stores the calculation result in the rotation axis information storage unit 123 of the data memory 12.

The processor 11A calculates a distance from the acceleration sensor 2A or 2B to the rotation axis AX by using the setting information stored in the setting information storage unit 121, the acceleration information stored in the reception information storage unit 122, and the determination result as to whether the rotation axis AX is located inside or outside the glow stick 6, which is stored in the rotation axis information storage unit 123 (step S15). The distance calculation method is different depending on whether the rotation axis AX is located inside or outside the glow stick 6. Details of the calculation method will be described later. The processor 11A stores the calculation result in the rotation axis information storage unit 123 of the data memory 12.

The processor 11A calculates an attitude angle α of the glow stick 6 by using the setting information stored in the setting information storage unit 121 and the distance from the acceleration sensor 2A or 2B to the rotation axis AX stored in the rotation axis information storage unit 123 (step S16). Details of the calculation method will be described later. The processor 11A stores the calculation result in the attitude angle information storage unit 124 of the data memory 12.

The processor 11A displays a video of the glow stick 6 on the display device PD of the performer PE and/or the display device AD of each audience AU (step S17). That is, the processor 11A generates a video for displaying the glow stick 6 on the basis of the information regarding the rotation axis AX stored in the rotation axis information storage unit 123 and the attitude angle α stored in the attitude angle information storage unit 124 and stores the video in the video storage unit 125. At this time, the processor 11A generates a video in which not only a motion of the glow stick 6 serving as the motion acquisition target object in the processing of the flowchart, but also a motion of the glow stick 6 of another audience AU is reflected. Then, the processor 11A transmits the video stored in the video storage unit 125 to the display device PD and/or the display device AD via the network NW through the communication interface 13 and displays the video thereon.

The processor 11A determines whether to end the processing (step S18). The processor 11A can perform the determination depending on whether or not an instruction to end viewing distribution has been received from the audience AU via the network NW through the communication interface 13. When it is determined not to end the processing, the processor 11A proceeds to the processing in step S11 described above. Meanwhile, when it is determined to end the processing, the processor 11A ends the processing routine of the flowchart.

Details of the processing in each step will be described below.

### <Determination on Whether Rotation Axis is Located Inside or Outside>

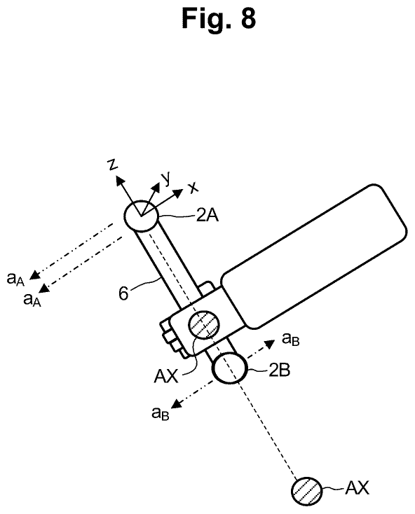

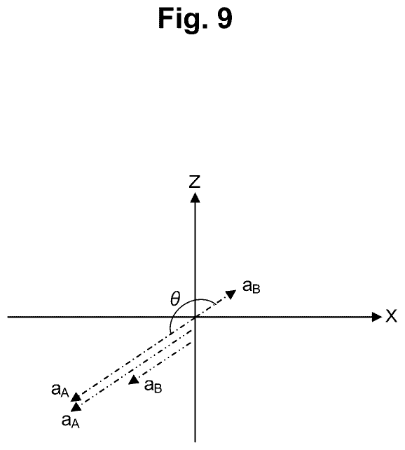

In step S13, the processor 11A determines whether or not the rotation axis AX is located between the two acceleration sensors 2A and 2B, that is, in the present embodiment, whether the rotation axis AX is located inside or outside the glow stick 6. FIG. 8 is a schematic diagram illustrating a relationship between the position of the rotation axis AX and the acceleration vectors of the acceleration sensors 2A and 2B included in the glow stick 6 serving as the motion acquisition target object. FIG. 9 illustrates the acceleration vectors in the same coordinate system.

When the audience AU swings the glow stick 6 around the wrist, for example, the rotation axis AX is located inside the glow stick 6. In this case, an acceleration vector a detected by the acceleration sensor 2A and an acceleration vector as detected by the acceleration sensor 2B are in opposite directions. When the audience AU swings the glow stick 6 around the elbow, for example, the rotation axis AX is located outside the glow stick 6. In this case, the acceleration vector as detected by the acceleration sensor 2A and the acceleration vector a_{B} detected by the acceleration sensor 2B are in the same direction.

An angle θ formed by the acceleration vector aa and the acceleration vector as is as follows.

$$θ = arccos ( \frac{{a}_{A} \cdot {a}_{B}}{\vert {a}_{A} \vert \vert {a}_{B} \vert} ) \qquad [ Math . 1 ]$$

The processor 11A determines whether the rotation axis AX is located inside or outside the glow stick 6 on the basis of a value of 0. Specifically, when the following expression

$$θ \leq \frac{π}{2} \qquad [ Math . 2 ]$$

holds, the processor 11A determines that the rotation axis AX is located outside the glow stick 6, and, when the following expression

$$θ > \frac{π}{2} \qquad [ Math . 3 ]$$

holds, the processor 11A determines that the rotation axis AX is located inside the glow stick 6.

### <Calculation of Rotation Plane>

In step S14, the processor 11A calculates the rotation plane that is the swing direction of the glow stick 6 projected on the XY plane in the world coordinate system (XYZ). There are two calculation methods for the calculation.

### (Pattern 1)

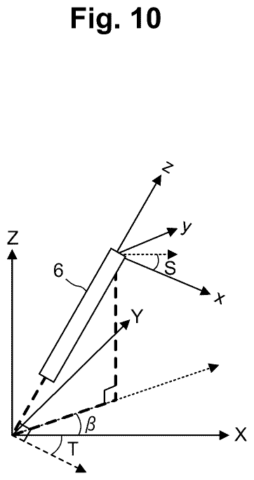

FIG. 10 illustrates a relationship between the world coordinate system (XYZ) and a coordinate system (xyz) of the glow stick 6 serving as the motion acquisition target object. By causing the audience AU to swing the glow stick 6 vertically or horizontally before the start of the processing in FIG. 7, the processor 11A defines in advance transformation between a screen coordinate system that is the world coordinate system (XYZ) and the glow stick coordinate system. For example, when the audience swings the glow stick 6 horizontally, that is, swings the glow stick 6 in the x-axis direction, the processor 11A obtains an angle T formed with the X-axis of the world coordinate system at that time and stores the angle T in the setting information storage unit 121 as one of setting values.

In step S14, the processor 11A obtains the swing direction in the glow stick coordinate system, that is, an angle S formed with the x-axis on the basis of an xy component of the acceleration vector. Then, the processor 11A transforms the swing direction in the glow stick coordinate system (xyz) into a swing direction β in the screen coordinate system (XYZ). Specifically, the swing direction β is obtained from β=S−T.

### (Pattern 2)

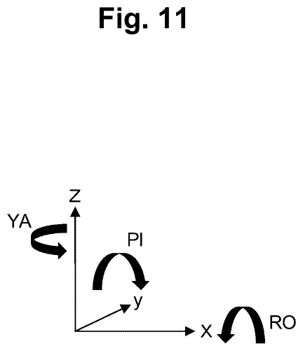

FIG. 11 illustrates the swing direction in a case where the coordinate system (xyz) of the glow stick 6 serving as the motion acquisition target object is fixed with respect to the world coordinate system (XYZ). There will be described a state in which the front of the glow stick 6 is fixed with respect to the screen of the display device AD, and vertical and horizontal swing surfaces are fixed with respect to the y-z plane and the x-z plane. A roll RO, which is rotation around the x-axis in the glow stick coordinate system, is a vertical swing, and a pitch PI, which is rotation around the y-axis, is a horizontal swing. Rotation around the z-axis, which is torsion of the glow stick 6, is not considered herein.

The processor 11A compares an x-direction acceleration with a y-direction acceleration, and, in a case where the x-axis acceleration is smaller, the processor 11A calculates that the glow stick 6 is vertically swung, that is, the y-axis direction is the swing direction. Meanwhile, in a case where the y-axis direction acceleration is smaller, the processor 11A calculates that the glow stick 6 is horizontally swung, that is, the x-axis direction is the swing direction.

<Calculation of Distance from Rotation Axis>

In step S15, the processor 11A calculates the distance from the acceleration sensor 2A or 2B to the rotation axis AX. The calculation method is different depending on whether the rotation axis AX is located inside or outside the glow stick 6.

(Case where Rotation Axis AX is Located Outside Glow Stick 6)

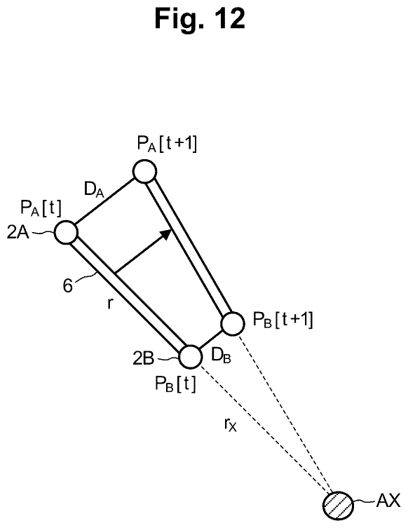

FIG. 12 illustrates variables used for estimating the rotation axis in a case where the rotation axis AX is located outside the glow stick 6 serving as the motion acquisition target object. The following variables are defined as follows:
P_{A}[t]: a position of the acceleration sensor 2A at a
P_{B}[t]: a position of the acceleration sensor 2B at the time t;
r: a length (known) of the glow stick 6; and
r_{X}: a length from the rotation axis AX (variable to be obtained). That is, here, description will be made on the assumption that the processor 11A obtains the length r_{X} from the acceleration sensor 2B of the two acceleration sensors 2A and 2B to the rotation axis AX. The length r of the glow stick 6 is stored in the setting information storage unit 121 as one of the setting values.

Here, when the following are defined
D_{A}: a distance for which the acceleration sensor 2A moves after Δt [sec]
D_{B}: a distance for which the acceleration sensor 2B moves after Δt [sec],
a triangle <AX·P_{A}[t]·P_{A}[t+1]> and a triangle <AX·P_{B}[t]·P_{B}[t+1]> are in similarity relation, and thus the following expressions hold.
D_{A}:D_{B}=(r+r_{X}):r_{X}
D_{B}(r+r_{X})=D_{A}r_{X}
D_{B}r+D_{B}r_{X}=D_{A}r_{X}
(D_{A}−D_{B})r_{X}=D_{B}r
∴r_{X}=D_{B}r/(D_{A}−D_{B}) Therefore, when the distances D_{A} and D_{B} are obtained, the length r_{X} is obtained.

Here, the following are defined:
γ_{A}[t]: a linear acceleration of the acceleration sensor 2A observed at the time t;
γ_{B}[t]: a linear acceleration of the acceleration sensor 2B observed at the time t;
V_{A}: a speed of the acceleration sensor 2A at the time t; and
V_{B}: a speed of the acceleration sensor 2B at the time t. Note that the linear acceleration means an acceleration excluding a gravitational acceleration and, for example, can be obtained by applying a high-pass filter to acceleration data obtained by the acceleration sensor.

When γ_{A}, γ_{B}, V_{A}, and V_{B} are used, the distances D_{A} and D_{B} are expressed as follows.

$${D}_{A} = {V}_{A} Δ t + ( {γ}_{A} [ t ] Δ {t}^{2} ) / 2 \\ {D}_{B} = {V}_{B} Δ t + ( {γ}_{B} [ t ] Δ {t}^{2} ) / 2$$

It is difficult to accurately obtain the speeds V_{A} and V_{B} on the basis of the acceleration sensors 2A and 2B. However, when focusing on a timing of turning back the glow stick 6, both the speeds V_{A} and V_{B} can be regarded as zero.

Here, a turning-back time t₀ is defined as a time at which signs of accelerations γ_{A}[t₀−1] and γ_{A}[t₀] and signs of accelerations γ_{B}[t₀−1] and γ_{B}[t₀] are reversed. At the start of motion from a stationary state, it is also possible to calculate a case where γ_{A}[t₀−1]=γ_{B}[t₀−1]=0: the glow stick 6 is stationary, and γ_{A}[t₀] γ_{B}[t₀] is not 0.

Because V_{A}=0 and V_{B}=0 are satisfied at the time to, the following expressions hold.

$${D}_{A} = ( {γ}_{A} [ {t}_{0} ] Δ {t}^{2} ) / 2$$

$${D}_{B} = ( {γ}_{B} [ {t}_{0} ] Δ {t}^{2} ) / 2$$

Therefore, the processor 11A can calculate the length r_{X} from the acceleration sensor 2B to the rotation axis AX from the following expression.

r_{X}=D_{B}r/(D_{A}−D_{B})

(Case where Rotation Axis AX is Located Inside Glow Stick 6)

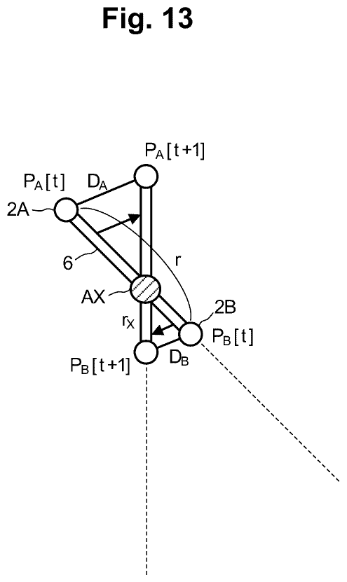

FIG. 13 illustrates variables used for estimating the rotation axis in a case where the rotation axis AX is located inside the glow stick 6 serving as the motion acquisition target object. The following variables are defined as follows:
P_{A}[t]: a position of the acceleration sensor 2A at a time t;
P_{B}[t]: a position of the acceleration sensor 2B at the time t;
r: a length (known) of the glow stick 6; and
r_{X}: a length from the rotation axis AX (variable to be obtained). Also here, description will be made on the assumption that the processor 11A obtains the length r_{X} from the acceleration sensor 2B of the two acceleration sensors 2A and 2B to the rotation axis AX.

Here, when the following are defined
D_{A}: a distance for which the acceleration sensor 2A moves after Δt [sec]
D_{B}: a distance for which the acceleration sensor 2B moves after Δt [sec],
a triangle <AX·P_{A}[t]·P_{A}[t+1]> and a triangle <AX·P_{B}[t]·P_{B}[t+1]> are in similarity relation, and thus the following expressions hold.
D_{A}:D_{B}=(r−r_{X}):r_{X}
D_{B} (r−r_{X})=D_{A}r_{X}
D_{B}r−D_{B}r_{X}=D_{A}r_{X}
(D_{A}+D_{B})r_{X}=D_{B}r
∴ r_{X}=D_{B}r/(D_{A}+D_{B}) Therefore, when the distances D_{A} and D_{B} are obtained, the length r_{X} is obtained.

Here, when the following are defined
γ_{A}[t]: a linear acceleration of the acceleration sensor 2A observed at the time t
γ_{B}[t]: a linear acceleration of the acceleration sensor 2B observed at the time t
V_{A}: a speed of the acceleration sensor 2A at the time t
V_{B}: a speed of the acceleration sensor 2B at the time t,
the distances D_{A} and D_{B} are expressed as follows.

$${D}_{A} = {V}_{A} Δ t + ( {γ}_{A} [ t ] Δ {t}^{2} ) / 2$$

$${D}_{B} = {V}_{B} Δ t + ( {γ}_{B} [ t ] Δ {t}^{2} ) / 2$$

When V_{A}=0 and V_{B}=0 are satisfied at the time to, the following expressions hold.

$${D}_{A} = ( {γ}_{A} [ {t}_{0} ] Δ {t}^{2} ) / 2$$

$${D}_{B} = ( {γ}_{B} [ {t}_{0} ] Δ {t}^{2} ) / 2$$

Therefore, the processor 11A can calculate the length r_{X} from the acceleration sensor 2B to the rotation axis AX from the following expression.

r_{X}=D_{B}r/(D_{A}+D_{B})

### <Calculation of Attitude Angle>

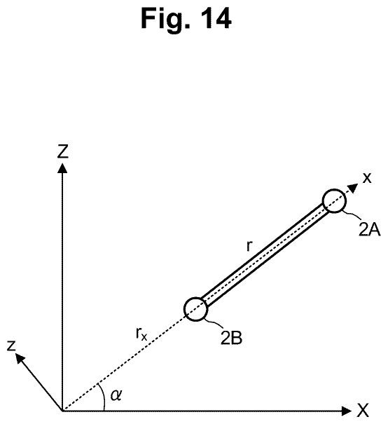

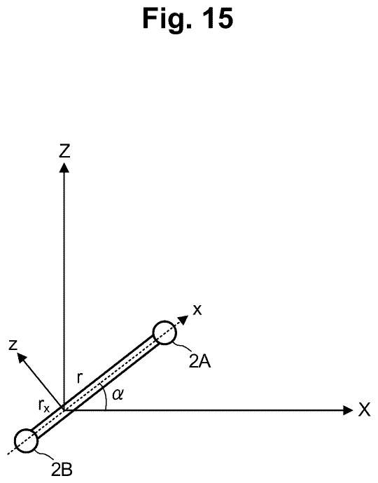

In step S16, the processor 11A calculates the attitude angle α of the glow stick 6. FIG. 14 illustrates variables used for calculating the attitude angle in a case where the rotation axis AX is located outside the glow stick 6 serving as the motion acquisition target object. FIG. 15 illustrates variables used for calculating the attitude angle in a case where the rotation axis AX is located inside the glow stick 6.

The attitude angle α is defined as an angle formed between the XY plane of the world coordinate system (XYZ) and the longitudinal direction of the glow stick 6. Further, a larger value is used by comparing the x-axis direction and the y-axis direction of acceleration. Hereinafter, a case where the x-axis direction acceleration is larger will be described.

The sum of the gravitational acceleration and the acceleration due to the motion is detected by each of the acceleration sensors 2A and 2B. Here,
the x-axis direction and the z-axis direction of the acceleration acquired by the acceleration sensor 2A are denoted by a_{Ax} and a_{Az}, respectively,
the x-axis direction and the z-axis direction of the acceleration acquired by the acceleration sensor 2B are denoted by a_{Bx} and a_{Bz}, respectively, and the attitude angle (rotation around the Y-axis, the pitch PI) of the glow stick on the XZ plane is denoted by α.

As illustrated in FIG. 14, in a case where the rotation axis AX is located outside the glow stick 6, the distances from the rotation axis AX to the acceleration sensors 2A and 2B are (r+r_{X}) and r_{X}, respectively. Thus, the processor 11A calculates the attitude angle α from the following expression.

$$α = arctan ( \frac{- {r}_{x} {a}_{Ax} + ( r + {r}_{x} ) {a}_{Bx}}{{r}_{x} {a}_{Az} - ( r + {r}_{x} ) {a}_{Bz}} ) \qquad [ Math . 4 ]$$

As illustrated in FIG. 15, in a case where the rotation axis AX is located inside the glow stick 6, the distances from the rotation axis AX to the acceleration sensors 2A and 2B are (r−r_{X}) and r_{X}, respectively. Thus, the processor 11A calculates the attitude angle α from the following expression.

$$α = arctan ( \frac{- {r}_{x} {a}_{Ax} + ( r - {r}_{x} ) {a}_{Bx}}{{r}_{x} {a}_{Az} - ( r - {r}_{x} ) {a}_{Bz}} ) \qquad [ Math . 5 ]$$

### <Video Display>

In step S17, the processor 11A displays the video of the glow stick 6 on the display device PD of the performer PE and/or the display device AD of each audience AU.

### (Reflection of Position of Rotation Axis AX)

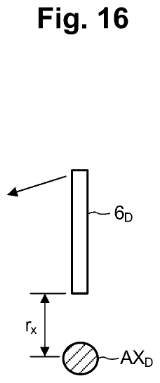

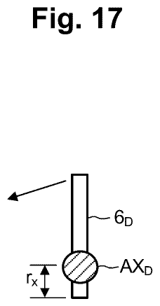

FIG. 16 illustrates a method of reflecting the position of the rotation axis in video display of the glow stick 6 serving as the motion acquisition target object in a case where the rotation axis AX is located outside the glow stick 6. FIG. 17 illustrates a method of reflecting the position of the rotation axis in video display of the glow stick 6 in a case where the rotation axis AX is located inside the glow stick 6. FIGS. 16 and 17 illustrate a glow stick image 6_{D} that is a video of the glow stick 6 in which a position AX_{D} of the rotation axis AX, which is not actually displayed in the video display, is drawn.

The processor 11A fixes the position AX_{D} of the rotation axis AX in the video display and changes a drawing position of the glow stick image 6_{D} in accordance with the distance r_{X} from the rotation axis AX calculated in the z-axis direction of the glow stick coordinate system. Therefore, it is possible to display a motion of the glow stick image 6_{D} so as to distinguish between a case where the audience AU rotates the glow stick 6 around the wrist and a case where the audience AU rotates the glow stick 6 around the elbow.

### (Reflection of Attitude Angles (α, β))

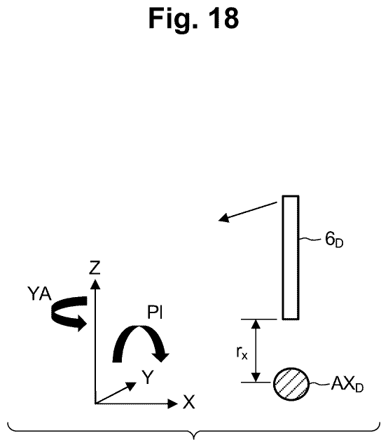

FIG. 18 illustrates a method of reflecting the attitude angle in video display of the glow stick 6 serving as the motion acquisition target object.

The processor 11A draws the glow stick image 6_{D} on the basis of the pitch angle (attitude angle α calculated in step S16) and a yaw angle (swing direction β obtained in step S14) in the world coordinate system (XYZ). This makes it possible to reproduce the attitude angle of the glow stick 6.

As described above in detail, in the first embodiment of this invention, the two acceleration sensors 2A and 2B are arranged in the glow stick 6 serving as the motion acquisition target object rotated around the rotation axis AX, and the information acquisition unit 3 acquires the acceleration information detected by the two acceleration sensors 2A and 2B, and thus the motion analysis unit 4 estimates the distance from one of the acceleration sensors 2A and 2B to the rotation axis AX and the attitude angle of the glow stick 6 on the basis of the acceleration information acquired by the information acquisition unit 3.

Therefore, according to the first embodiment, not only the attitude angle of the glow stick 6 but also the rotation axis AX is estimated by using only the two acceleration sensors 2A and 2B. This makes it possible to acquire a difference in the motion of the glow stick 6 without detecting the difference from the outside of the glow stick 6.

The two acceleration sensors 2A and 2B are arranged in the glow stick 6 so as to be separated from each other in the radial direction of the rotation.

Therefore, it is possible to determine whether or not the rotation axis AX is located between the two acceleration sensors 2A and 2B, that is, whether the rotation axis AX is located inside or outside the glow stick 6, on the basis of a difference in direction between the acceleration information from the acceleration sensor 2A and the acceleration information from the acceleration sensor 2B.

The motion analysis unit 4 calculates the swing direction of the glow stick 6 in the world coordinate system serving as a reference coordinate system on the basis of the acceleration information, calculates the distance from one of the two acceleration sensors 2A and 2B to the rotation axis AX on the basis of the acceleration information and the distance between the two acceleration sensors 2A and 2B, and calculates the attitude angle of the glow stick 6 on the basis of the distance between the two acceleration sensors 2A and 2B, the calculated swing direction of the glow stick 6, and the calculated distance from the rotation axis AX.

Therefore, it is possible to calculate the distance from the rotation axis AX and the attitude angle of the glow stick 6 on the basis of the acceleration information from the two acceleration sensors 2A and 2B.

Further, the motion analysis unit 4 determines whether or not the rotation axis AX is located between the two acceleration sensors 2A and 2B on the basis of the acceleration information acquired by the information acquisition unit 3, and calculation methods in the calculation of the distance from the rotation axis AX and in the calculation of the attitude angle of the glow stick 6 are different between a case where the rotation axis AX is located between the two acceleration sensors 2A and 2B and a case where the rotation axis AX is not located between the two acceleration sensors 2A and 2B.

Therefore, the distance from the rotation axis AX and the attitude angle of the glow stick 6 can be accurately calculated by using the calculation method according to the position of the rotation axis AX.

Further, in the first embodiment, the motion analysis unit 4 determines whether or not the rotation axis AX is located between the two acceleration sensors 2A and 2B on the basis of the acceleration information acquired by the information acquisition unit 3, and the video display unit 5 displays the image of the glow stick 6 as a video on the display device PD and/or the display device AD on the basis of the distance from the rotation axis AX, the attitude angle of the glow stick 6, and the determination result as to whether or not the rotation axis AX is located between the two acceleration sensors 2A and 2B.

This makes it possible to provide video display in which the motion of the glow stick 6 is reproduced.

### Second Embodiment

Next, a second embodiment of this invention will be described. In the following description, the same parts as those in the first embodiment will be denoted by the same reference signs as those in the first embodiment, and the description thereof will be omitted.

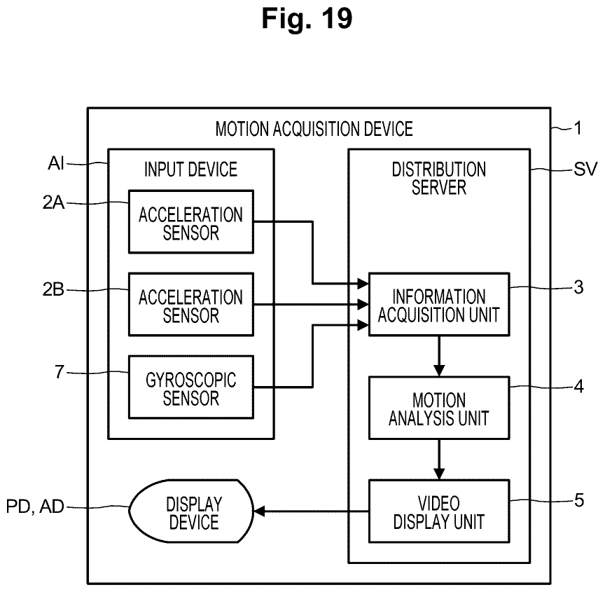

FIG. 19 illustrates a block diagram illustrating an example of a configuration of the motion acquisition device 1 according to the second embodiment of this invention. In the second embodiment, the input device AI includes a gyroscopic sensor 7 that detects an angular velocity in addition to the configuration of the first embodiment.

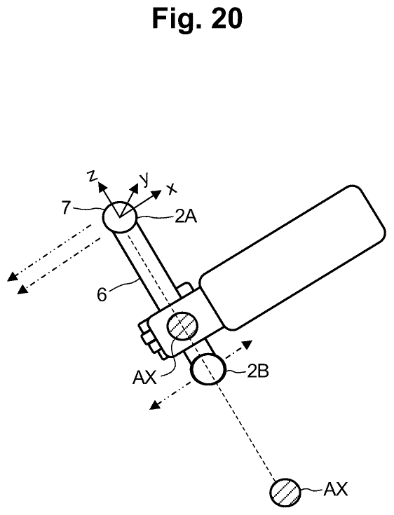

FIG. 20 is a schematic diagram illustrating an example of the motion acquisition target object serving as the input device AI. Also in the second embodiment, the input device AI is provided in the form of the glow stick 6 gripped by the audience AU. The gyroscopic sensor 7 is installed at the same position as one of the two acceleration sensors 2A and 2B. For example, as illustrated in FIG. 20, the gyroscopic sensor 7 is installed at the same position as the acceleration sensor 2A. In this case, the gyroscopic sensor 7 is installed such that three axes (x-axis, y-axis, and z-axis) thereof are aligned with the three axes of the acceleration sensor 2A.

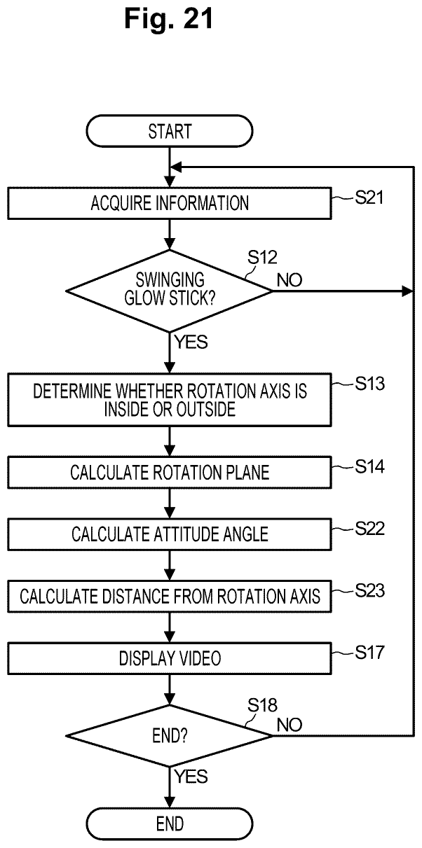

FIG. 21 is a flowchart showing a processing routine in the motion acquisition device 1 according to the second embodiment. The processor 11A of the motion acquisition device 1 can execute the processing in the flowchart by executing the motion acquisition program stored in advance in the program memory 11B, for example. The processor 11A executes the motion acquisition program when receiving an instruction to start viewing distribution from the audience AU via the network NW through the communication interface 13. Note that the processing routine in the flowchart shows processing for one input device AI, and the processor 11A can perform similar processing in parallel for the plurality of input devices AI.

The processor 11A operates as the information acquisition unit 3 to acquire acceleration information and angular velocity information (step S21). That is, the processor 11A receives, through the communication interface 13, acceleration information from the two acceleration sensors 2A and 2B arranged in the glow stick 6 serving as the input device AI and angular velocity information from the gyroscopic sensor 7, the acceleration information and the angular velocity information being transmitted via the network NW, and stores the acceleration information and the angular velocity information in the reception information storage unit 122 of the data memory 12.

The processor 11A determines whether or not the audience AU is swinging the glow stick 6 on the basis of the acceleration information, as in the first embodiment (step S12). When it is determined that the audience AU is not swinging the glow stick 6, the processor 11A proceeds to the processing in step S21 described above.

When it is determined that the audience AU is swinging the glow stick 6, the processor 11A determines whether or not the rotation axis AX is located between the two acceleration sensors 2A and 2B, that is, whether the rotation axis AX is located inside or outside the glow stick 6 in the present embodiment as well as in the first embodiment (step S13).

The processor 11A calculates a rotation plane that is the swing direction of the glow stick 6 by using the setting information stored in the setting information storage unit 121 and the acceleration information stored in the reception information storage unit 122, as in the first embodiment (step S14).

The processor 11A calculates the attitude angle α of the glow stick 6 by using the acceleration information and the angular velocity information stored in the reception information storage unit 122 (step S22). Details of the calculation method will be described later. The processor 11A stores the calculation result in the attitude angle information storage unit 124 of the data memory 12.

The processor 11A calculates a distance from the glow stick 6 to the rotation axis AX by using the setting information stored in the setting information storage unit 121, the acceleration information stored in the reception information storage unit 122, and the determination result as to whether the rotation axis AX is located inside or outside the glow stick 6, which is stored in the rotation axis information storage unit 123 (step S23). The distance calculation method is different depending on whether the rotation axis AX is located inside or outside the glow stick 6. Details of the calculation method will be described later. The processor 11A stores the calculation result in the rotation axis information storage unit 123 of the data memory 12.

The processor 11A displays the video of the glow stick 6 on the display device PD of the performer PE and/or the display device AD of each audience AU, as in the first embodiment (step S17).

The processor 11A determines whether to end the processing, as in the first embodiment (step S18). When the processor 11A determines not to end the processing, the processing proceeds to the processing in step S21, whereas, when the processor determines to end the processing, the processor ends the processing routine in the flowchart.

Hereinafter, details of the processing in steps S22 and S23 will be described.

### <Calculation of Attitude Angle>

In step S22, the processor 11A calculates the attitude angle α of the glow stick 6. The attitude angle α is defined as an angle formed between the XY plane of the world coordinate system (XYZ) and the longitudinal direction of the glow stick 6.

### (Case of Using Only Acceleration Information)

When the x-axis direction and the z-axis direction of the acceleration acquired by the acceleration sensor 2A or 2B are denoted by aₓ and a_{z}, respectively, the processor 11A can calculate a pitch rotation angle p from the following expression.

$$p = arctan ( \frac{{a}_{x}}{{a}_{z}} ) \qquad [ Math . 6 ]$$

The calculated pitch rotation angle p corresponds to the attitude angle α on the XZ plane. In the method of calculating the attitude angle α on the basis of the acceleration information, it is possible to calculate the attitude angle α more accurately in a case where the motion acquisition target object performs a low-frequency motion than in a case where the motion acquisition target object performs a high-frequency motion.

### (Case of Using Only Angular Velocity Information)

When the angular velocity information acquired by the gyroscopic sensor 7 is denoted by (ωₓ, ω_{y}, ω_{z}), rotation angles (δφ, δθ, δψ) around the x, y, and z axes in a certain minute time δt can be expressed as follows.

(δφ, δθ, δψ)=(ωχδt, ωγδt, ωζδ)

When roll-pitch-yaw rotation angles are denoted by (δᵣ, δₚ, δ_{y}),

the processor 11A can calculate a pitch rotation angle δₚ from the following expression.

$$[ \begin{matrix}δ r \\ δ p \\ δ y\end{matrix} ] = [ \begin{matrix}1 & {S}_{r} \frac{{S}_{p}}{{C}_{p}} & {C}_{r} \frac{{S}_{p}}{{C}_{p}} \\ 0 & {C}_{r} & - {S}_{r} \\ 0 & {S}_{r} \frac{1}{{C}_{p}} & {C}_{r} \frac{1}{{C}_{p}}\end{matrix} ] [ \begin{matrix}δϕ \\ δθ \\ δψ\end{matrix} ] \qquad [ Math . 7 ]$$

Here, C_{θ} represents cos θ, and S_{θ} represents sin θ.

The calculated pitch rotation angle δₚ corresponds to the attitude angle α on the XZ plane. In the method of calculating the attitude angle α on the basis of the angular velocity information, it is possible to calculate the attitude angle α more accurately in a case where the motion acquisition target object performs a high-frequency motion than in a case where the motion acquisition target object performs a low-frequency motion.

### (Case of Using Acceleration Information and Angular Velocity Information)

Accuracy of the attitude angle α is poor by using only the acceleration information or by using only the angular velocity information. Thus, the accuracy can be enhanced by sensor fusion.

For example, a complementary filter that calculates a weighted sum of an angle calculated by applying a low-pass filter to the acceleration information and an angle calculated by applying a high-pass filter to the angular velocity information is used. Specifically, the processor 11A calculates a corrected attitude angle x from the following expression.

$$Corrected attitude angle = k * ( attitude angle calculated based on angular velocity information ) + ( 1 - k ) * ( attitude angle calculated based on acceleration information )$$

As described above, by using the acceleration information and the angular velocity information, the processor 11A can accurately calculate the attitude angle x both in a case where the motion acquisition target object is stationary and in a case where the motion acquisition target object is moving.

The present embodiment is not limited to the complementary filter, and other filters such as a Kalman filter and a gradient filter may be used.

<Calculation of Distance from Rotation Axis>

In step S23, the processor 11A calculates the distance from the glow stick 6 serving as the motion acquisition target object, that is, in the present embodiment, from a lower end of the glow stick 6 in which the acceleration sensor 2B is arranged, to the rotation axis AX. Also in the second embodiment, the calculation method is different depending on whether or not the rotation axis AX is located between the two acceleration sensors 2A and 2B, that is, whether the rotation axis AX is located inside or outside the glow stick 6.

(Case where Rotation Axis AX is Located Outside Glow Stick 6)

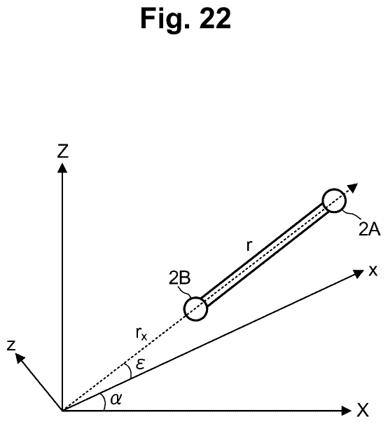

FIG. 22 illustrates variables used for estimating the rotation axis in a case where the rotation axis AX is located outside the glow stick 6 serving as the motion acquisition target object. Here, a larger value is used by comparing the x-axis direction and the y-axis direction of acceleration. Hereinafter, a case where the x-axis direction acceleration is larger will be described.

When the longitudinal axis of the glow stick 6 in motion is set as the xz coordinate system that is an instantaneous stationary coordinate system, and an acceleration (ε=0) in the xz coordinate system in a state in which the glow stick 6 has moved by a minute angle ε in the coordinate system and gravity transformed into the xz coordinate system are added, it is possible to obtain the accelerations aₓ and a_{z} in the x-axis direction and the z-axis direction from the acceleration sensor 2A or 2B.

Here, when the following expression

$$\begin{matrix}[ Math . 8 ] & \\ \{ \begin{matrix}x = r cos ε , & z = r sin ε \\ \dot{x} = - r \dot{ε} sin ε , & \dot{z} = r \dot{ε} cos ε \\ \ddot{x} = - r \ddot{ε} sin ε - r {\ddot{ε}}^{2} cos ε , & \ddot{z} = r \dot{ε} cos ε - r {\ddot{ε}}^{2} sin ε\end{matrix} & ( 1 )\end{matrix}$$

holds, and ε=0 is satisfied,

the following expression is obtained.

$$\begin{matrix}[ Math . 9 ] & \\ \ddot{x} = - r {\dot{ε}}^{2} , \ddot{z} = r \ddot{ε} & ( 2 )\end{matrix}$$

Considering the accelerations a_{Ax} and a_{Az} acquired by the acceleration sensor 2A and the accelerations a_{Bx} and a_{Bz} acquired by the acceleration sensor 2B also in consideration of a gravitational acceleration g,

the following expressions are obtained.

$$\begin{matrix}[ Math . 10 ] & \\ {a}_{Ax} = {\ddot{x}}_{A} + g sin α = - ( {r}_{x} + r ) {\dot{ε}}^{2} + g sin α & ( 3 )\end{matrix}$$

$${a}_{Az} = {\ddot{z}}_{A} + g cos α = ( {r}_{x} + r ) \ddot{ε} + g cos α \qquad ( 4 )$$

$${a}_{Bx} = {\ddot{x}}_{B} + g sin α = - {r}_{x} {\dot{ε}}^{2} + g sin α \qquad ( 5 )$$

$${a}_{Bz} = {\ddot{z}}_{B} + g cos α = {r}_{x} \ddot{ε} + g cos α \qquad ( 6 )$$

Therefore, the processor 11A can calculate the length r_{X} from the acceleration sensor 2B arranged at the lower end of the glow stick 6 to the rotation axis AX from the following expression

$$\begin{matrix}[ Math . 11 ] & \\ {r}_{x} = \frac{2 g sin α - {a}_{Ax} - {a}_{Bx}}{2 {\dot{ε}}^{2}} - \frac{1}{2} r & ( 7 )\end{matrix}$$

by using the above expressions (3) and (5).

(Case where Rotation Axis AX is Located Inside Glow Stick 6)

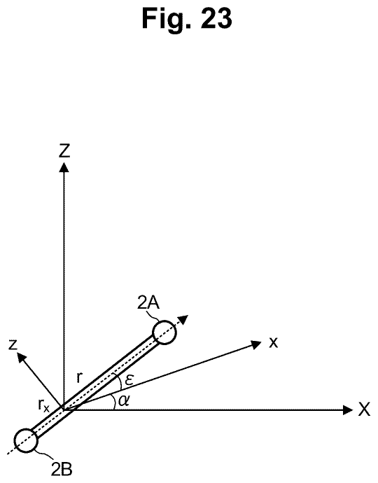

FIG. 23 illustrates variables used for estimating the rotation axis in a case where the rotation axis AX is located inside the glow stick 6 serving as the motion acquisition target object. Here, a larger value is used by comparing the x-axis direction and the y-axis direction of acceleration. Hereinafter, a case where the x-axis direction acceleration is larger will be described.

When the longitudinal axis of the glow stick 6 in motion is set as the xz coordinate system that is an instantaneous stationary coordinate system, and an acceleration (ε=0) in the xz coordinate system in a state in which the glow stick 6 has moved by a minute angle & in the coordinate system and gravity transformed into the xz coordinate system are added, it is possible to obtain the accelerations aₓ and a_{z} in the x-axis direction and the z-axis direction from the acceleration sensor 2A or 2B.

Here, considering the accelerations a_{Ax} and a_{Az} acquired by the acceleration sensor 2A and the accelerations a_{Bx} and a_{Bz} acquired by the acceleration sensor 2B also in consideration of the gravitational acceleration g, the following expressions

$$\begin{matrix}[ Math . 12 ] & \\ {a}_{Ax} = {\ddot{x}}_{A} + g sin α = - ( r - {r}_{x} ) {\dot{ε}}^{2} + g sin α & ( 8 )\end{matrix}$$

$${a}_{Az} = {\ddot{z}}_{A} + g cos α = ( r - {r}_{x} ) \ddot{ε} + g cos α \qquad ( 9 )$$

$${a}_{Bx} = {\ddot{x}}_{B} + g sin α = - {r}_{x} {\dot{ε}}^{2} + g sin α \qquad ( 10 )$$

$${a}_{Bz} = {\ddot{z}}_{B} + g cos α = {r}_{x} \ddot{ε} + g cos α \qquad ( 11 )$$

are obtained by using the above expressions (1) and (2).

Therefore, the processor 11A can calculate the length r_{X} from the acceleration sensor 2B arranged at the lower end of the glow stick 6 to the rotation axis AX from the following expression

$$\begin{matrix}[ Math . 13 ] & \\ {r}_{x} = \frac{{a}_{Ax} - {a}_{Bx}}{2 {\dot{ε}}^{2}} + \frac{1}{2} r & ( 12 )\end{matrix}$$

by using the above expressions (8) and (10).

As described above in detail, in the second embodiment of this invention, the two acceleration sensors 2A and 2B and the gyroscopic sensor 7 serving as one angular velocity sensor are arranged in the glow stick 6 serving as the motion acquisition target object rotated around the rotation axis AX, and the information acquisition unit 3 acquires the acceleration information detected by the two acceleration sensors 2A and 2B and the angular velocity information detected by the one gyroscopic sensor 7, and thus the motion analysis unit 4 estimates the distance from the glow stick 6 to the rotation axis AX and the attitude angle of the glow stick 6 on the basis of the acceleration information and the angular velocity information acquired by the information acquisition unit 3.

Therefore, according to the second embodiment, not only the attitude angle of the glow stick 6 but also the rotation axis AX is estimated by using only the two acceleration sensors 2A and 2B the one gyroscopic sensor 7. This makes it possible to acquire a difference in the motion of the glow stick 6 without detecting the difference from the outside of the glow stick 6.

The two acceleration sensors 2A and 2B are arranged in the glow stick 6 so as to be separated from each other in the radial direction of the rotation, and the one gyroscopic sensor 7 is arranged at the same position as one of the two acceleration sensors 2A and 2B.

Therefore, it is possible to determine whether or not the rotation axis AX is located between the two acceleration sensors 2A and 2B, that is, whether the rotation axis AX is located inside or outside the glow stick 6, on the basis of a difference in direction between the acceleration information from the acceleration sensor 2A and the acceleration information from the acceleration sensor 2B.

The motion analysis unit 4 calculates the swing direction of the glow stick 6 in the world coordinate system serving as the reference coordinate system on the basis of the acceleration information, calculates the attitude angle of the glow stick 6 on the basis of the acceleration information and the angular velocity information, and calculates the distance from the glow stick 6 to the rotation axis AX on the basis of the calculated swing direction of the glow stick 6, the acceleration information, and the distance between the two acceleration sensors 2A and 2B.

Therefore, it is possible to calculate the distance from the rotation axis AX and the attitude angle of the glow stick 6 on the basis of the acceleration information from the two acceleration sensors 2A and 2B and the angular velocity information from the one gyroscopic sensor 7.

Further, the motion analysis unit 4 determines whether or not the rotation axis AX is located between the two acceleration sensors 2A and 2B on the basis of the acceleration information acquired by the information acquisition unit 3, and a calculation method in the calculation of the distance from the rotation axis AX is different between a case where the rotation axis AX is located between the two acceleration sensors 2A and 2B and a case where the rotation axis AX is not located between the two acceleration sensors 2A and 2B.

Therefore, the distance from the rotation axis AX can be accurately calculated by using the calculation method according to the position of the rotation axis AX.

In the second embodiment, as well as in the first embodiment, the motion analysis unit 4 determines whether or not the rotation axis AX is located between the two acceleration sensors 2A and 2B on the basis of the acceleration information acquired by the information acquisition unit 3, and the video display unit 5 displays the image of the glow stick 6 as a video on the display device PD and/or the display device AD on the basis of the distance from the rotation axis AX, the attitude angle of the glow stick 6, and the determination result as to whether or not the rotation axis AX is located between the two acceleration sensors 2A and 2B.

This makes it possible to provide video display in which the motion of the glow stick 6 is reproduced.

### Third Embodiment

Next, a third embodiment of this invention will be described. In the following description, the same parts as those in the first embodiment will be denoted by the same reference signs as those in the first embodiment, and the description thereof will be omitted.

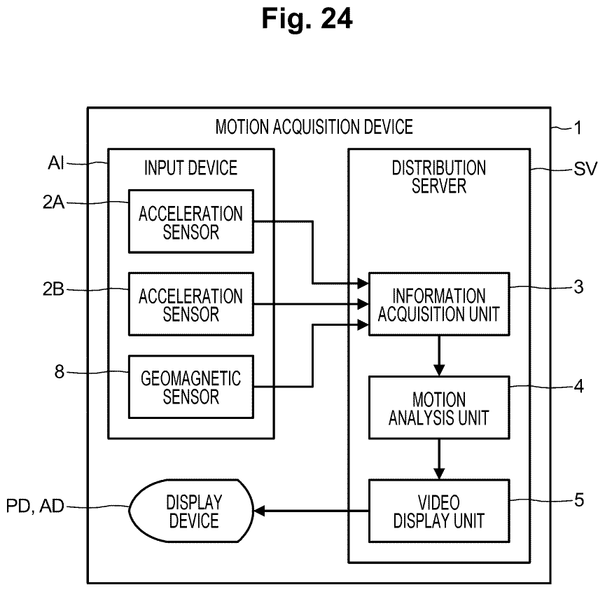

FIG. 24 illustrates a block diagram illustrating an example of a configuration of the motion acquisition device 1 according to the third embodiment of this invention. In the third embodiment, the input device AI includes a geomagnetic sensor 8 that is an orientation sensor in addition to the configuration of the first embodiment.

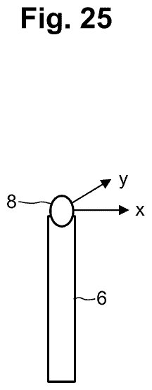

FIG. 25 is a schematic diagram illustrating an example of the motion acquisition target object serving as the input device AI. Also in the third embodiment, the input device AI is provided in the form of the glow stick 6 gripped by the audience AU. As illustrated in FIG. 25, one geomagnetic sensor 8 is installed at an end of the glow stick 6 in a direction in which the xy plane of the geomagnetic sensor 8 exists on a plane orthogonal to the longitudinal direction of the glow stick 6.

The geomagnetic sensor 8 acquires a geomagnetic intensity. When the center of a circle of an output distribution diagram obtained when the geomagnetic sensor 8 is horizontally rotated is denoted by (Pₓ, P_{y}), and the geomagnetic intensity acquired by the geomagnetic sensor 8 is denoted by (X, Y), an angle from the magnetic north is obtained as follows.

$$Angle from magnetic north = arctan \frac{Y - {P}_{y}}{X - {P}_{x}} \qquad [ Math . 14 ]$$

The above expression can be used only in a case where the xy plane of the geomagnetic sensor 8 is orthogonal to the vertical direction, and thus the processor 11A selects a measurement timing by any of the following methods.
When the pitch angle (attitude angle α) is 90 degrees (after the attitude angle is calculated)
An intermediate time between two turning-back timings of the swing of the glow stick 6
A timing at which speed is maximum (which is calculated based on acceleration)

The processor 11A operating as the motion analysis unit 4 can know an orientation of the glow stick 6 on the basis of the geomagnetic intensity acquired by the geomagnetic sensor 8. When a direction in which the screen of the display device AD is located is acquired and stored in advance in the setting information storage unit 121, the processor 11A can determine an angle (angle T in FIG. 10) formed between the front of the screen and the front of the glow stick 6. That is, it is possible to define transformation between the world coordinate system (XYZ) of the screen and the coordinate system (xyz) of the glow stick 6.

This eliminates the need for performing an operation (calibration) of obtaining transformation between the screen coordinate system and the coordinate system of the glow stick 6 by causing the audience AU to swing the glow stick 6 and an operation of fixing a front direction of the glow stick 6, which are described in the rotation plane calculation processing of the first embodiment. This makes it possible to reduce a burden on the audience AU.

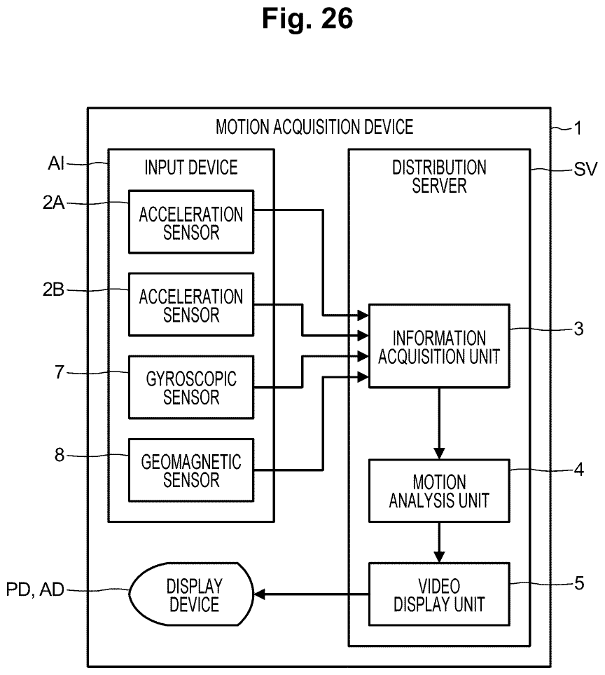

FIG. 26 illustrates a block diagram illustrating another example of the configuration of the motion acquisition device 1 according to the third embodiment of this invention. As described above, the geomagnetic sensor 8 is similarly applicable not only to the first embodiment but also to the motion acquisition device 1 according to the second embodiment.

As described above in detail, the third embodiment of this invention includes, in addition to the configuration of the first or second embodiment, the geomagnetic sensor 8 that is an orientation sensor arranged at the end in the longitudinal direction of the glow stick 6 such that the xy plane of detection exists in a direction orthogonal to the longitudinal direction of the glow stick 6 serving as the radial direction of the rotation.

Therefore, according to the third embodiment, it is possible to reduce a burden on the audience AU by using output of the geomagnetic sensor 8 serving as the orientation sensor.

### Other Embodiments

This invention is not limited to the above embodiments.

For example, in the above embodiments, swing motions around the wrist and the elbow have been described as an example. However, it is needless to say that not only the swing but also a motion of raising the arm and performing a circular motion around the shoulder above the head can be detected.

The motion acquisition target object is not limited to the shape of the glow stick 6 and may have any form as long as the audience AU can hold the motion acquisition target object. Further, the motion acquisition target object may be in any form other than being gripped by the audience AU. For example, the motion acquisition target object may be worn on a body of the audience AU such as the arm. In this case, the motion acquisition target object is rotated or turned around the elbow or the shoulder as the rotation axis or a turning axis. Thus, this case can be regarded similarly as the case where the rotation axis AX is located outside the glow stick 6 described in the above embodiments.

Further, in the above embodiments, live streaming between the performer PE and the audience AU has been described as an example. However, for example, it is needless to say that this invention can be applied to various applications such as a virtual match of Kendo by regarding the glow stick 6 as a bamboo sword.

The flow of the processing described with reference to each flowchart is not limited to the described procedure, and the order of some steps may be replaced, some steps may be performed simultaneously in parallel, or the processing content of some steps may be modified.

The method described in each embodiment can be stored as a processing program (software means) that can be executed by a computer in a recording medium such as a magnetic disk (e.g. Floppy (registered trademark) disk or hard disk), an optical disc (e.g. CD-ROM, DVD, or MO), or a semiconductor memory (e.g. ROM, RAM, or flash memory) or can be distributed by being transmitted through a communication medium. Note that programs stored in the medium also include a setting program for configuring, in the computer, the software means (including not only an execution program but also a table and a data structure) to be executed by the computer. The computer that implements the present device executes the above-described processing by reading the programs recorded in the recording medium, configuring the software means by using the setting program as necessary, and controlling operation by the software means. Note that the recording medium described in the present specification is not limited to a recording medium for distribution, but includes a storage medium such as a magnetic disk or a semiconductor memory provided in the computer or in a device connected via a network.

In short, this invention is not limited to the above embodiments without any change and can be embodied by modifying the components without departing from the gist of the invention at the implementation stage. Further, various inventions can be formed by appropriately combining a plurality of components disclosed in the above embodiments. For example, some components may be deleted from all the components described in the embodiments. Further, components in different embodiments may be appropriately combined.

### REFERENCE SIGNS LIST

1 Motion acquisition device
2A, 2B Acceleration sensor
3 Information acquisition unit
4 Motion analysis unit
5 Video display unit
6 Glow stick
6_{D} Glow stick image
7 Gyroscopic sensor
8 Geomagnetic sensor
11A Processor
11B Program memory
12 Data memory
121 Setting information storage unit
122 Reception information storage unit
123 Rotation axis information storage unit
124 Attitude angle information storage unit
125 Video storage unit
13 Communication interface
14 Bus
AD, AD1, AD2, AD3, ADn, PD Display device
AI, AI1, AI2, AI3, AIn Input device
AU, AU1, AU2, AU3, AUn Audience
AX Rotation axis
AX_{D} Position of rotation axis
PC Imaging device
PE Performer
SV Distribution server
NW Network

1. A motion acquisition device comprising:
two acceleration sensors arranged in a motion acquisition target object rotated around a rotation axis;
information acquisition circuitry that acquires acceleration information detected by the two acceleration sensors; and
motion analysis circuitry that estimates a distance from one of the acceleration sensors to the rotation axis and an attitude angle of the motion acquisition target object on the basis of the acceleration information acquired by the information acquisition circuitry.

2. The motion acquisition device according to claim 1, wherein:
the two acceleration sensors are arranged in the motion acquisition target object so as to be separated from each other in a radial direction of the rotation.

3. The motion acquisition device according to claim 1, wherein the motion analysis circuitry:
calculates a swing direction of the motion acquisition target object in a reference coordinate system on the basis of the acceleration information,
calculates the distance from the one of the acceleration sensors to the rotation axis on the basis of the acceleration information and a distance between the two acceleration sensors, and
calculates the attitude angle of the motion acquisition target object on the basis of the distance between the two acceleration sensors, the calculated swing direction of the motion acquisition target object, and the calculated distance from the rotation axis.

4. The motion acquisition device according to claim 3, wherein:
the motion analysis circuitry determines whether or not the rotation axis is located between the two acceleration sensors on the basis of the acceleration information acquired by the information acquisition circuitry; and
calculation methods in the calculation of the distance from the rotation axis and the calculation of the attitude angle of the motion acquisition target object are different between a case where the rotation axis is located between the two acceleration sensors and a case where the rotation axis is not located between the two acceleration sensors.

5. The motion acquisition device according to claim 1, further comprising:
an orientation sensor arranged in the motion acquisition target object such that an xy plane of detection exists in a direction orthogonal to a radial direction of the rotation.

6. The motion acquisition device according to claim 1, wherein:
the motion analysis circuitry determines whether or not the rotation axis is located between the two acceleration sensors on the basis of the acceleration information acquired by the information acquisition circuitry; and
the motion acquisition device further includes a video display circuitry that displays an image of the motion acquisition target object as a video on the basis of the distance from the rotation axis, the attitude angle of the motion acquisition target object, and a determination result as to whether or not the rotation axis is located between the two acceleration sensors.

7. A motion acquisition method, comprising:
acquiring acceleration information detected by two acceleration sensors arranged in a motion acquisition target object; and
estimating a distance from one of the acceleration sensors to a rotation axis and an attitude angle of the motion acquisition target object on the basis of the acquired acceleration information.

8. A non-transitory computer readable medium storing a motion acquisition program for causing a computer to perform the method of claim 7.
